(19) United States
(12) Patent Application Publication
(10) Pub. No.: US 2026/0252769 A1
(43) Pub. Date: Aug. 27, 2026

(54) METHOD AND SYSTEM FOR PREDICTING LEAK HOLE SIZE IN A PIPELINE OR PRESSURE VESSEL AND FLOW RATE FROM A LEAK HOLE

(71) Applicant: VANMOK INC., Edmonton (CA)

(72) Inventors: Hamed Ghasvari JAHROMI, Edmonton (CA); Fatemeh EKRAM, Edmonton (CA); Michael ROXAS, Edmonton (CA); Satya MOKAMATI, Edmonton (CA)

(21) Appl. No.: 19/065,199

(22) Filed: Feb. 27, 2025

(51) Int. Cl. G06F 30/28; G01F 1/00; G01M 3/00; G06F 111/10; G06F 113/08; G06F 113/14

(52) U.S. Cl. CPC G06F 30/28; G01F 1/00; G01M 3/00; G06F 2111/10; G06F 2113/08; G06F 2113/14

(57) ABSTRACT

A system and method are taught for predicting leak hole size in a pipeline or pressure vessel and flowrate from the leak hole. The system includes a processor; a database of real-world pipeline leak data; a memory on which are stored machine-readable instructions that when executed by the processor, cause the processor to generate a model configured to produce one or more groups of dimensionless numbers, wherein the model is generated in a multi-pronged approach comprising:
a) performing a Buckingham Pi analysis of one or more independent variables to determine one or more most relevant independent variables, from which the one or more groups of dimensionless numbers are generated;
b) executing a plurality of functional forms on the groups of dimensionless numbers and using the real-world pipeline leak data as input; and
c) predicting leak hole size or velocity of fluid exiting the leak hole of a pipeline from a direct solver set of equations and an inverse solver set of equations, based on the model and the one or more groups of dimensionless numbers.

### FIELD

The present disclosure relates to methods and systems for predicting size of leak holes in a pipeline or pressure vessel, and for predicting flow rate of fluids from the leak hole.

### BACKGROUND

Leak holes or leaks in pressurized vessels and pipelines, including surface and buried onshore pipelines or offshore pipeline positioned below sea level, can lead to loss of product, environmental damage and danger to humans.

Prediction of when or where a leak hole may occur in a pressurized system become important to simulation, testing, operations and process control. Further, there is a strong need for prediction of how quickly and how much of the leaked substance is exiting the pressurized system.

In the past, the approach to leak prediction is by tackling each leak event at a time using either experimental data or time-consuming computational fluid dynamic case studies. There has been no general methodology for estimation of the velocity of a jet of leaked substance, for all general conditions of the inside of a pressurized system. As well, there has been no general methodology for the estimation of the hole size from which an estimation of flow rate can be made. Currently these parameters are predicted using only particular experimental case studies or particular numerical simulation to provide a solution for a particular range of the particular independent variables studied. There is no general method for estimation of the leak jet velocity for a variety of ranges and shapes of leak holes and also for a range of liquids from water to dense phase fluids such as natural gas or liquid CO₂.

The prior art approach of predicting one particular case at a time, leads to a lack of sufficient data points generated or studied for a global result or more generalized solution.

The prior methods lack both speed and accuracy of predictive results; traditionally a single case study for determining a correct prediction usually takes hours up to days, demands costly subscriptions to commercial software and a lot of expertise to use such software. The effort of predicting a particular result is not often then usable in future cases over time, which will have their own particular conditions.

A need therefore exists for a general solution that can encompass a number of variables.

### SUMMARY

A system is provided for predicting leak hole size in a pipeline or pressure vessel and flowrate from the leak hole. The system includes a processor; a database of real-world pipeline leak data; a memory on which are stored machine-readable instructions that when executed by the processor, cause the processor to generate a model configured to produce one or more groups of dimensionless numbers, wherein the model is generated in a multi-pronged approach comprising:
a) performing a Buckingham Pi analysis of one or more independent variables to determine one or more most relevant independent variables, from which the one or more groups of dimensionless numbers are generated;
b) executing a plurality of functional forms on the dimensionless numbers and using the real-world pipeline leak data as input; and
c) predicting leak hole size and velocity of fluid exiting the leak hole of a pipeline from a direct solver set of equations and an inverse solver set of equations, based on the model and the one or more dimensionless numbers.

A method is provided for predicting leak hole size in a pipeline or pressure vessel and flowrate from the leak hole. The method includes: determining, by a processor, one or more independent variables related to pipeline operation; generating a model configured to produce one or more groups of dimensionless numbers, wherein the model is generated in a multi-pronged approach comprising:
a) performing by the processor a Buckingham Pi analysis of one or more independent variables to determine one or more most relevant independent variables,
b) developing, by the processor, a model to determine from the one or more relevant independent variables, one or more groups of dimensionless numbers,
c) executing, by the processor, a plurality of functional forms on the one or more groups of dimensionless numbers and using real-world pipeline leak data as an in input; and
d) predicting, by the processor, at least one of a leak hole size and velocity of fluid flowing from the leak hole by a direct solver set of equations and an inverse solver set of equations, based on the model and the one or more dimensionless numbers.

A non-transitory computer readable medium is taught, comprising instructions, that when read by a processor, cause the processor to perform: determining, by a processor, one or more independent variables related to pipeline operation; performing, by the processor, a Buckingham Pi analysis of the one or more independent variables to determine one or more most relevant independent variables; developing, by the processor, a model to determine from the one or more relevant independent variables, one or more groups of dimensionless numbers, executing, by the processor, a plurality of functional forms incorporating the one or more groups of dimensionless numbers and using real-world pipeline leak data as an in input; and predicting, by the processor, at least one of a leak hole size and velocity of fluid flowing from the leak hole.

It is to be understood that other aspects of the present disclosure will become readily apparent to those skilled in the art from the following detailed description, wherein various embodiments of the disclosure are shown and described by way of illustration. As will be realized, the disclosure is capable of other and different embodiments and its several details are capable of modification in various other respects, all without departing from the spirit and scope of the present disclosure. Accordingly, the drawings and detailed description are to be regarded as illustrative in nature and not as restrictive.

### BRIEF DESCRIPTION OF THE DRAWINGS

A further, detailed, description of the disclosure, briefly described above, will follow by reference to the following drawings of specific embodiments of the disclosure. The drawings depict only typical embodiments of the disclosure and are therefore not to be considered limiting of its scope. In the drawings:

FIG. 1 illustrates a simulation model of a pipeline rupture;

FIG. 2 illustrates an example of a logic flow diagram and system architecture of the present method

FIG. 3 is a depiction of all possible combination of variables to form groups of dimensionless numbers;

FIG. 4 is a graph depicting the correlation between Froude values and Ghasvari values of the present disclosure, at varying values of the Mokamati number;

FIG. 5 is a graph depicting the correlation between Froude values and Ghasvari values of the present disclosure, at varying values of the Mokamati number zoomed in for a narrow range of the Ghasvari number;

FIG. 6 is a graph depicting the correlation between Froude values and Mokamati values of the present disclosure, at varying values of the Ghasvari number;

FIG. 7 is a graph depicting the correlation between Reynolds values and Ghasvari values of the present disclosure, at varying values of the Mokamati number for buried pipelines at specific particle size for different sand porosity;

FIG. 8 is a graph depicting the correlation between Reynolds values and Ghasvari values of the present disclosure, at varying values of the Mokamati number for buried pipelines at specific particle size for different sand porosity;

FIG. 9 is a graph depicting the leak flowrate for different pressure differences across a leak location, for varying types of liquids; and

FIG. 10 is a graph depicting the leak flowrate for different pressure differences across a leak location, for varying hole sizes.

The drawings are not necessarily to scale and in some instances, proportions may have been exaggerated in order to more clearly depict certain features.

### DETAILED DESCRIPTION

The description that follows and the embodiments described therein are provided by way of illustration of an example, or examples, of particular embodiments of the principles of various aspects of the present disclosure. These examples are provided for the purposes of explanation, and not of limitation, of those principles and of the disclosure in its various aspects.

The present disclosure provides a method and system for predicting leak hole size in pressurized systems and for predicting flow rates of leaked substances through said leak holes. More particularly the present system and method uses similarity and group theory, particularly a singular intermediate asymptotic method, to find unique dimensionless numbers to determine velocity of leaked substance out of said leak holes.

The present methods and systems can be incorporated into software or as a module for automation and computation, or for simulation and analysis. The present system can work with other systems that use machine-based learning applications to predict leak location. The present system provides methods for calculating predicted leak hole size and flowrate or velocity of the released substances from known or estimated geometry of the predicted leak hole. The flow is either in the form of an outgoing jet of high velocity in cases of pressurized systems at surface, or a creeping flow when in sand or high resistance surroundings. The present method can apply to pressurized vessels in soil, liquid or exposed to the air, during fluid flowing conditions or in non-flowing conditions.
The present method utilizes simulated leak tests (SLT) using actual archived and historical data and in the case of new pipelines, a pipeline with any arbitrary topography can be manipulated to behave in a manner that forms a digital twin of the main physical pipeline. Because of 1-1 correlations, it is possible to exactly simulate the inception of any hole, crack, etc., at any location along the length of the pipeline and using the knowledge of pressure at the location it is possible to anticipate the minimum size of the hole that can be detected.
The present method allows for precise calculation of otherwise ‘key missing parameters’ such as leak rate given any degraded condition inside the pipeline or pressure vessel.
As a first step of developing a model of the present disclosure, the present software is set up with a Direct solver for calculating the velocity of the fluid leaving a leak hole in a case where the leak hole shape and dimensions are known:

### Where:

ρ is density of the fluidic leaking substance
μ is viscosity of the fluidic leaking substance
ΔP is pressure drop across the leak hole
g is gravitational constant
V is velocity of fluid leaving the leak hole
d is leak hole geometry

In this case, density and viscosity of a particular fluid is either already known or can be estimated using real-time transient models (RTTM). Pressure drop is also estimated from knowing the pressure at the start of the pipeline and the pressure at the end of the pipeline and can be then determined from RTTM and gravity is a known constant. To build a model for development of the present system different samples of sizes and shapes of leak holes were used to represent variety of real-world leaks. Using the values on the left side of the box, the present direct method can be used to estimate or predict the velocity of fluid leaving the leak hole.

Once the direct model is run multiple times for various sizes of leak holes for particular fluids (water in this case) and at different pressure drops, Graph 1 is generated, showing a curve for modeling each of several pressure drops. From this graph, it is possible to obtain a leak flowrate on the vertical axis from the intersection of the known hole diameter on the horizontal axis as it intersects an associated pressure drop curve.

### Graph 1

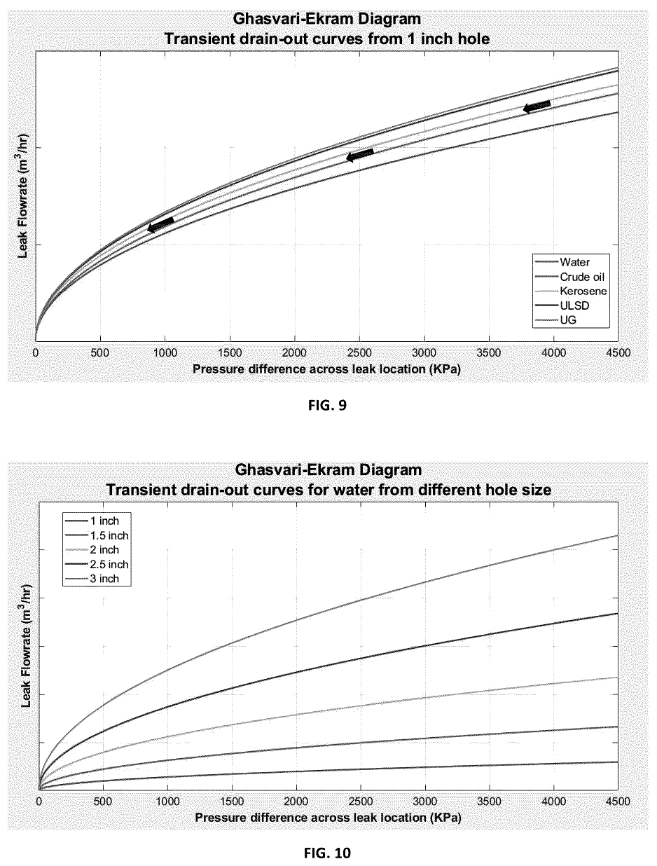

In cases where a particular pressure drop curve is not provided, it is possible to either interpolate using the graph, or alternatively by inputting data into the above direct solver with a particular pressure drop and run in a software application to create further pressure drop curves for particular fluids to create further curves and further graphs of similar format to Graph 1, such as FIGS. 9 and 10.

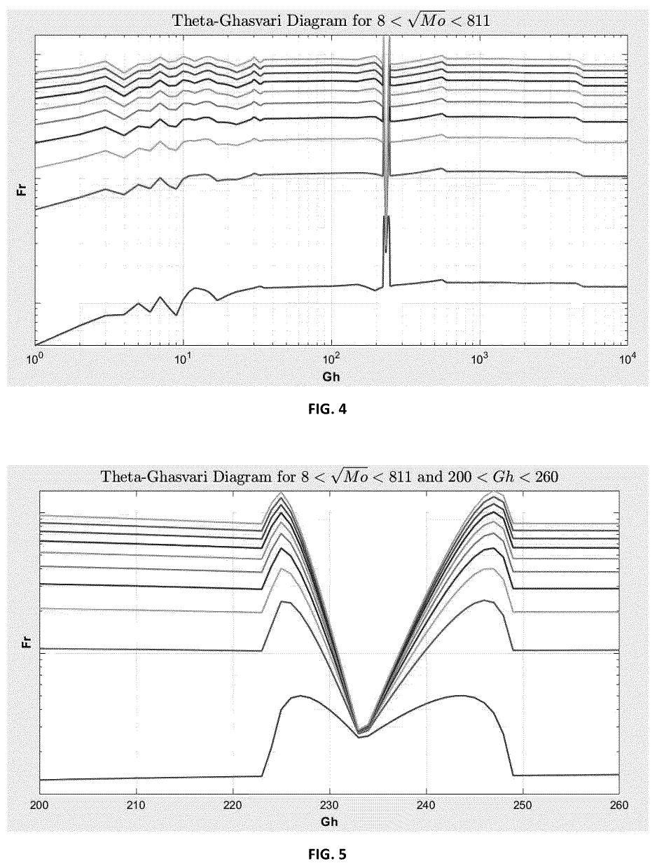

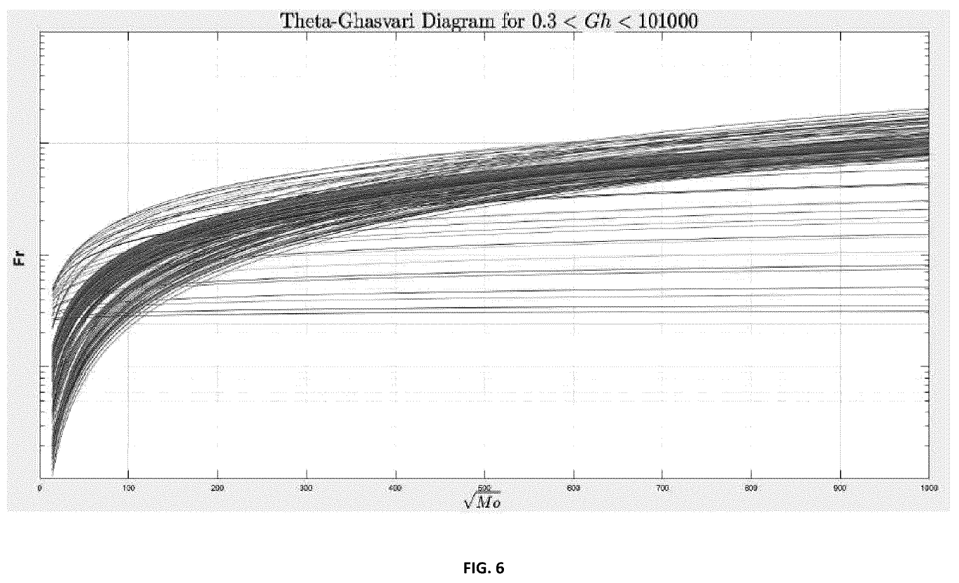

Graph 1 above and FIGS. 4-10 are different forms of presenting the direct and inverse applications of the following functional forms.

$$Fr = {f}_{j} ( Gh , Mo ) \qquad for pipelines above the ground$$

$$Re = {f}_{i} ( Gh , Mo , δ , ε ) \qquad for burried pipelines$$

The components of which are described below.

For calculating a leak hole size using known parameters, the following Inverse Solver has been developed that can be run in an application on a computer:

As before, density and viscosity are known fluid properties, or they can be estimated using (RTTM). Pressure drop is also estimated from RTTM. Gravity is a known constant. The velocity at which fluid leaves from an arbitrary leak hole in the pipeline is estimated also from the RTTM.

Using the values on the left side of the box, the leak hole size is predicted from the Inverse Solver, using newly derived Pi groups, that are described in more detail below.

Referring again to Graph 1, reproduced again below, with leak flowrate determined from leak velocity, and pressure drop known as described above, a correlation can be made to predict a leak hole diameter from the intersection of the known flowrate and the associated curve for the pressure. The particular example of fluid in the graph below is water, although it would be understood that any number of fluids could be modeled as such. If the curve of a particular estimated pressure drop is not plotted on the graph, it is possible to interpolate this, or alternatively the above Inverse solver can be run in a software application to generate further pressure drop curves for particular fluids or further graphs of similar format to Graph 1, such as FIGS. 9 and 10

### Calculating Hole Size (Inverse):

Estimation of hole size is a trial-and-error process comprising the steps of:
1—making an initial estimate of hole size
2—calculating the fluid velocity using the above formula with the estimated hole size and known fluid density, fluid viscosity and gravity constant.
3—comparing known velocities at particular hole sizes as determined from real world leak data, with the calculated velocity—if the difference is less than a prescribed tolerance, then the estimated hole size can be used going forward; if the difference is greater than a prescribed tolerance then a new hole size is estimated and steps 2 and 3 are repeated with the new estimated hole size.

### Independent and Dependent Variables:

The present inventors explored the interaction of various independent variables and their collective impact on the dependent variable, namely velocity of the fluid during a leakage:
1. Viscosity (“μ”): Determines a fluid's flow resistance, as measured in centipoise (cP). Different viscosities can considerably alter the flow rate, particularly through narrow apertures. A viscosity range of 1 cP≤μ≤350 cP was used since it represents typical industry operation.
2. Density (“ρ”): Indicates the fluid's mass per unit volume and significantly affects its reaction to external pressures. A density range of 535 kg/m3≤ρ≤1010 kg/m3 was used since it represents typical industry operation.
3. Pressure Differential (Δp): Refers to the pressure variation between an inside the pipeline/vessel and its ambient surroundings, measured in psi, playing a key role in determining fluid ejection speed. A pressure differential range of 50 psi≤Δp≤900 psi was used since it represents typical industry operation.
4. Pipeline Thickness (“th”): Influences the pipeline's structural robustness and its vulnerability to leaks.
5. Volumetric Flow Rate (“Q”): Denotes the fluid volume passing through a pipeline segment over time.
6. Pipeline Diameter (“D_i”): Dictates the broader flow dynamics within the pipeline.
7. Leak Hole Geometry (“d”): The leak rate can differ based on the hole's size and shape. A leak hole diameter range of 1/16 inch≤d≤7 inch was used for testing.
8. Gravitational Constant (“g”): Regulates the gravitational impact on fluid behavior.
9. Particle size of the sand (δ) which is a number belonging to a range of 50 to 200 micrometers.
10. Sand porosity (ε) which is dimensionless number belonging to the range of 20% to 40%.

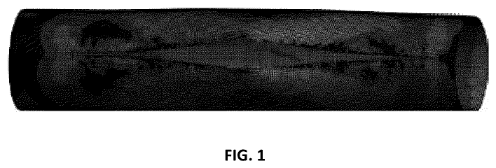

In order to model fluid velocity for all possible combination the above independent variables, leak flow rate analysis was performed in order to estimate the leak flow rates for various hole shapes and sizes using Computational Fluid Dynamics (CFD). The following are the typical leak hole shapes observed in a pipeline:
Circular or round holes,
Fissures/Axial slot/crack-like holes, as illustrated in FIG. 1,
Square hole: such as those formed by equipment punching a hole into a pipeline or pressure vessel,
Crescent-shaped hole: as seen in a rupture along a longitudinal seam of a pipeline.

The present method uses CFD software to model three-dimensional hole shapes and predict or model leak flow through these hole shapes, by setting boundary conditions at the inlet and outlet of the pipeline, including but not limited to inlet and outlet pressure and inlet and outlet velocity. By utilizing CFD the leak flow through different hole sizes and shapes and a 3D flow field local to the leak site can be determined.

In a validation process involving multiple CFD case studies, the prediction outcomes were found to mirror expected results with an acceptable error margin.

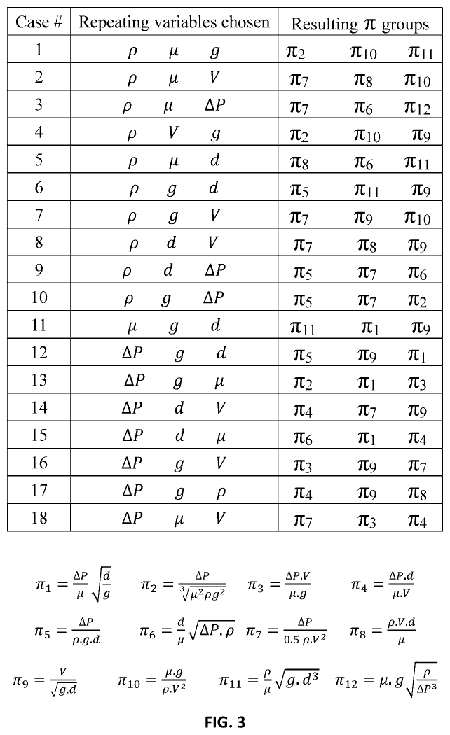

A Buckingham Pi analysis was conducted on the independent variables of the present method and it was determined through this analysis that pipeline diameter, wall thickness, and volumetric flow rate did not significantly affect the fluidic charge dynamics through a leak hole. Thus, the primary variables of interest were determined to be hole diameter, fluid viscosity, fluid density, pipeline pressure difference, and the constant of gravity. Employing 18 possible combinations of finding 3 Pi numbers from 6 of these primary variables and unitizing dimensional analysis based on the Buckingham Pi theory, led to the formation of groups of dimensionless values, each called a Pi (π) value, with the groups called Pi (π) groups. This is illustrated in FIG. 3. Out of a possible 18 π groups derived from the primary variables, three π numbers were identified as being the most relevant among these:

π₅, π₉ and π₁₁.

$${π}_{5} = \frac{Δ P}{p \cdot g \cdot d} , {π}_{9} = \frac{V}{\sqrt{g \cdot d}} , {π}_{11} = \frac{ρ}{μ} \sqrt{g \cdot {d}^{3}}$$

π₅ is named and hereinafter referred to as Mokamati number (Mo),
π₁₁ is named and hereinafter referred to as Ghasvari number (Gh),
π₉ is hereinafter referred to by its original name: Froude (Fr)

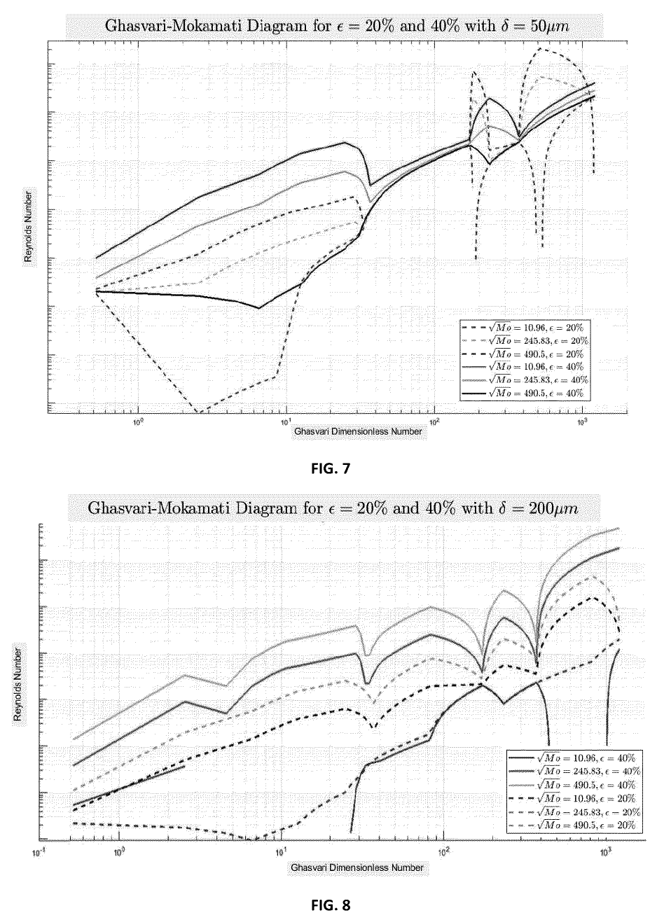

The present inventors have found a correlation among these three π numbers that leads to the creation of FIGS. 4,5 and 6 for pipelines above the ground and FIGS. 7 and 8 for buried pipelines that offer a useful reference for predicting fluid dynamics under particular scenarios.

Historically, fluid mechanics has seen numerous dimensionless numbers, like the Reynolds and Froude numbers. The present inventors have identified that when the three Pi numbers above are used in both the Direct and Inverse solvers above, the resulting leak hole size and flowrate through the leak hole can be determined with an acceptable error margin across all CFD simulated cases.

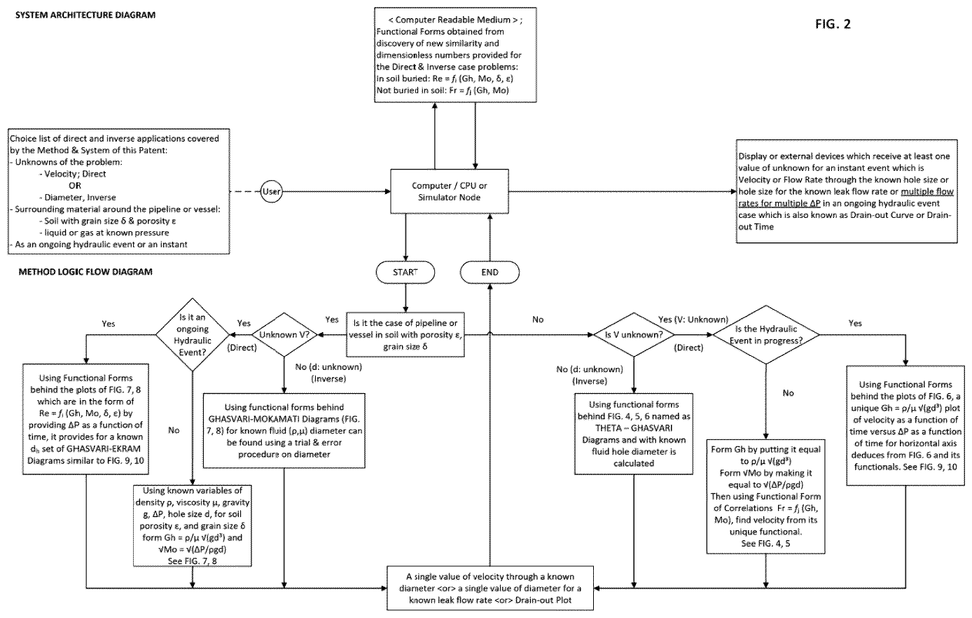

A multi-prong approach is taken in the present method to predict leaks in pipeline and vessels. In a first step the Buckingham Pi analysis is performed to determine the dimensionless π numbers. Then Functional forms are applied to the three π numbers. Functional forms are general forms that encapsulate all the parameters for both direct and inverse approach. That functional form analysis is then applied in both the direct and inverse approaches to determining either leak flow velocity or leak hole size as well as the possibility of determining a drain out time or plot for the case where the hydraulic event is ongoing as shown in the FIG. 2

The method can be extended to applications where the pipelines are buried under soil of differing grain sizes and porosities. The method can also be extended to applications where the fluid is a gas such as NGL, methane, CO₂ and other gases, to predict the leak rate and hole from them. The present method can aid in determination of line packing. Line packing is a term used to refer to the total volume of gas contained within a pipeline and is used as a means of balancing the load and volume of gas within the system with against downstream demand and withdrawal of product. In such instances downstream withdrawal and demand substitutes for leak flowrate and pipeline diameter substitutes for leak hole diameter. From this line packing, or volume of gas at particular pressures can be determined to ensure steady supply at varying demands.

The present method can also be used to determine flowrate and velocity of pipeline fluid through a gradually opening or closing pipeline valve, rather than through a leak. In this scenario the diameter is not of a leak hole, but rather of the valve opening as it is gradually opened or closed on the pipeline.

The method can be extended to apply for applications where the pipelines are submerged under water at different depths. Alternatively, the present method can also be used in buried pipelines or pressure vessels at a certain depth of soil.

The previous description of the disclosed embodiments is provided to enable any person skilled in the art to make or use the present disclosure. Various modifications to those embodiments will be readily apparent to those skilled in the art, and the generic principles defined herein may be applied to other embodiments without departing from the spirit or scope of the disclosure. Thus, the present disclosure is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. A system for predicting leak hole size or flowrate from a known leak hole in a pipeline or pressure vessel, comprising:
a processor;
a database of real-world pipeline leak data;
a memory on which are stored machine-readable instructions that when executed by the processor, cause the processor to:
generate a model configured to produce one or more groups of dimensionless numbers, wherein the model is generated in a multi-pronged approach comprising:
a) performing a Buckingham Pi analysis of one or more independent variables to determine one or more most relevant independent variables, from which the one or more groups of dimensionless numbers are generated;
b) executing a plurality of functional forms on the dimensionless numbers and using the real-world pipeline leak data as input; and
c) predicting leak hole size and velocity of fluid exiting the leak hole of a pipeline from a direct solver set of equations and an inverse solver set of equations, based on the model and the one or more groups of dimensionless numbers.

2. The system of claim 1, wherein the direct solver set of calculations calculate the velocity of the fluid exiting leak hole when leak hole shape and dimensions are known.

3. The system of claim 1, wherein the inverse solver set of calculations calculate leak hole size when velocity of fluid existing the leak hole is known.

4. The system of claim 1, wherein the model further is further configured to apply simulated leak tests (SLT) calculations to the real-world pipeline leak data.

5. The system of claim 1, wherein the independent variables comprise viscosity, density pressure differential, pipeline thickness, volumetric flow rate, pipeline diameter, leak hole geometry and gravitational constant.

6. The system of claim 5, wherein leak hole geometry is determined by computational fluid dynamics to model three-dimensional hole shapes.

7. A method for predicting leak hole size or flowrate from the leak hole in a pipeline or pressure vessel comprising:
determining, by a processor, one or more groups of independent variables related to pipeline operation;
generating a model configured to produce one or more groups of dimensionless numbers, wherein the model is generated in a multi-pronged approach comprising:
a) performing by the processor a Buckingham Pi analysis of one or more independent variables to determine one or more most relevant independent variables,
b) developing, by the processor, a model to determine from the one or more relevant independent variables, one or more groups of dimensionless numbers,
c) executing, by the processor, a plurality of functional forms on the one or more groups of dimensionless numbers and using real-world pipeline leak data as an in input; and
d) predicting, by the processor, at least one of a leak hole size and velocity of fluid flowing from the leak hole by a direct solver set of equations and an inverse solver set of equations, based on the model and the one or more groups of dimensionless numbers.

8. The method of claim 7, wherein the direct solver set of calculations calculate the velocity of the fluid exiting leak hole when leak hole shape and dimensions are known.

9. The method of claim 7, wherein the inverse solver set of calculations calculate leak hole size when velocity of fluid existing the leak hole is known.

10. The method of claim 7, wherein the model further is further configured to apply simulated leak tests (SLT) calculations to the real-world pipeline leak data.

11. The method of claim 7, wherein the independent variables comprise viscosity, density pressure differential, pipeline thickness, volumetric flow rate, pipeline diameter, leak hole geometry and gravitational constant.

12. The method of claim 11, wherein leak hole geometry is determined by computational fluid dynamics to model three-dimensional hole shapes.

13. A non-transitory computer readable medium comprising instructions, that when read by a processor, cause the processor to perform:
determining, by a processor, one or more independent variables related to pipeline operation;
performing, by the processor, a Buckingham Pi analysis of the one or more independent variables to determine one or more most relevant independent variables;
developing, by the processor, a model to determine from the one or more relevant independent variables, one or more groups of dimensionless numbers,
executing, by the processor, a plurality of functional forms incorporating the one or more groups of dimensionless numbers and using real-world pipeline leak data as an in input; and
predicting, by the processor, at least one of a leak hole size for the case of known leak flow rate or a velocity of fluid or flow rate flowing from a known leak hole.

14. The non-transitory computer readable medium of claim 13, wherein the direct solver set of calculations calculate the velocity of the fluid exiting leak hole when leak hole shape and dimensions are known.

15. The non-transitory computer readable medium of claim 13, wherein the inverse solver set of calculations calculate leak hole size when velocity of fluid existing the leak hole is known.

16. The non-transitory computer readable medium of claim 13, wherein the model further is further configured to apply simulated leak tests (SLT) calculations to the real-world pipeline leak data.

17. The non-transitory computer readable medium of claim 13, wherein the independent variables comprise viscosity, density pressure differential, pipeline thickness, volumetric flow rate, pipeline diameter, leak hole geometry and gravitational constant.

18. The non-transitory computer readable medium of claim 17, wherein leak hole geometry is determined by computational fluid dynamics to model three-dimensional hole shapes.
